(19) United States
(12) Patent Application Publication
(10) Pub. No.: US 2008/0298702 A1
(43) Pub. Date: Dec. 4, 2008

(54) Fixed rate JPEG encoding

(75) Inventors: Nageswara Rao Gunupudi, Bangalore (IN); Prasad Satya Vara Rongali, Bangalore (IN); Ramkishor Korada, Bangalore (IN)

Correspondence Address: WORKMAN NYDEGGER, 60 EAST SOUTH TEMPLE, 1000 EAGLE GATE TOWER, SALT LAKE CITY, UT, 84111, US

(73) Assignee: Aricent Inc., George Town (KY)

(21) Appl. No.: 12/156,766

(22) Filed: Jun. 4, 2008

(30) Foreign Application Priority Data
Jun. 4, 2007 (IN) 881/DEL/2007

(51) Int. Cl. G06K 9/00

(52) U.S. Cl. 382/251

(57) ABSTRACT

Systems and methods are disclosed for fixed rate JPEG encoding of a digital image. According to an implementation, the method includes estimation of image characteristics (e.g. frequency domain parameters—DCT coefficients, etc.) of a plurality of frequency components constituting the digital image. Subsequently, bits are allocated to each of the frequency components based on the estimated characteristics. Quantization value for each of the frequency component is computed based on the allocated bits and the estimated image characteristics.

### FIELD OF THE INVENTION

This invention relates to compression of digital images, and more particularly, to a method for compressing digital images within a fixed file size or bit rate.

### BACKGROUND OF THE INVENTION

JPEG is the ubiquitous image compression standard widely accepted in a variety of fields in the electronics industry such as image communications, multimedia personal computers, multimedia messaging services (MMS), digital still cameras (DSC), etc. Visual quality and file size of a compressed image are two important aspects of image encoding and hence in JPEG coding systems. Major steps in JPEG encoding includes block based DCT, quantization, and variable length encoding. JPEG standard recommendation allows encoders to define a set of tables referred to as quantization tables and entropy-coding tables respectively. The set of tables so defined are used in the process of encoding a digital image for quantization and variable length coding purposes respectively. The tables, in process of encoding, control the quality of image encoder and the compressibility or the rate of the image. The file size resulting after encoding the digital image depends on finer details of the digital image and the quantization and the entropy coding tables used during the encoding process.

Quantization table is the key parameter for JPEG image compression, because it controls both distortion and bit rate. Since the existing JPEG standard does not allow changing the quantization table in the middle of compressing a component of the image, the output file size/bit rate cannot be determined for JPEG image coding. In video coding, unlike JPEG, the quantization scale for a frame in video can be adjusted to control the final bit rate for the frame and hence the rate control for video is an on-job task.

The rate/file size for JPEG image encoding is controlled by Huffman table and quantization matrix, both of which need to be decided before the encoding is performed. The quantization tables suggested in the JPEG standard may be appropriate for applications where there is no constraint on output file size. The JPEG standard suggests two tables, one for luminance component, and one for chrominance component. These tables are optimized for the Human visual system (HVS) considering certain viewing distance of a given width of the digital image (typically 6 times the screen width). These tables may not guarantee a target compression ratio, but guarantees a distortion below a threshold of visibility.

Existing methods and systems control the file size of the compressed digital image by applying scalar multipliers to the suggested quantization table in the JPEG standard. The multipliers may be adjusted iteratively until a desired average bit rate is achieved. Such application of scalar multipliers and iterative adjustments results in huge computational complexity. Besides, the table yields noticeable artifacts when viewed on high quality displays and for images having lot of high frequency details where the quantization is coarse. Since the suggested quantization table is independent of image characteristics, rate distortion performance (R-D) is not optimal.

Various quantization and perceptual rate distortion optimization techniques developed for DCT based image codec include multi-pass encoding, scaled quantization, spectral zeroing, and perceptual quantization table design. Certain other methods for rate control of JPEG encoding involve iterative techniques where a single parameter, more generally referred to as “quality factor”, is iteratively adjusted in a predefined range of values (usually 0 to 100) to minimize the difference between the output file size and the required file size. The quality factor is used to scale the de-facto quantization table. Iterative or multi pass techniques are simple to design and ensure an appreciable R-D (Rate-Distortion) performance. However, the number of the passes required for achieving the final rate at minimal distortion is completely image dependent and hence computational complexity requirements are very high for practical implementations (an aspect that can adversely affect battery life of image capturing device). Other techniques involve finding a scale factor to scale a default quantization table values to meet the rate, where the scale factor is computed from the image activity and associated statistics. However, the R-D optimality of this technique is not guaranteed because the technique does not consider individual spectral frequency characteristics of the digital image. The scale factor based techniques may also be designed for iterative multi pass encoding.

The present invitation addresses the problem of compressing the digital images using JPEG compression system with an awareness of the bit rate i.e. the compressed file size and proposes a method of single pass technique based on a new heuristic mathematical model of image properties quantization table and rate in DCT domain. The method considers simple frequency characteristics of each component and derives the corresponding quantization component based on the heuristic mathematical model.

### SUMMARY OF THE INVENTION

Embodiments of the present invention are directed to systems and methods for fixed rate JPEG encoding. In particular, embodiments of the invention enable compression of a digital image to a fixed output file size.

According to an embodiment, the method includes estimation of image characteristics of a plurality of frequency components associated with the digital image. Subsequently, bits are allocated to each of the plurality of frequency components based on the estimated image characteristics. In a successive progression, a quantization value for each of the plurality of frequency components is derived. The derivation of the quantization value depends at least in part on the estimated image characteristics and corresponding allocated bits. Such a derivation of quantization value results in a controlled rate of JPEG encoding of the digital image.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 schematically illustrates an example of a system that may implement features of the present invention;

FIG. 2 schematically illustrates an exemplary JPEG encoder of FIG. 1 in further detail;

FIG. 3 depicts an exemplary sub-imager block of the digital image illustrating six non-linear frequency bands.

FIGS. 4a, 4b, and 4c illustrates graphs between bit rate (Approximate bits for encoding) and quantization scale for DC coefficient, first AC coefficient, and for first 4 coefficients in a zigzag scan order.

FIG. 5 illustrates a table that captures performance data associated with the single pass technique and iterative technique for controlled rate encoding.

FIG. 6a illustrates a graph of the transfer characteristics (required Vs. achieved compression ratios) for five natural images achieved with rate controlled JPEG encoding according to the present invention.

FIG. 6b illustrates a graph of the PSNR characteristics for different images when compressed using the rate controlled JPEG encoding.

FIG. 6c illustrates a graph between compression ratios and number of images being compressed in accordance with the present invention.

FIG. 7 illustrates a process for rate controlled JPEG encoding of a digital image according to an implementation.

FIG. 8 illustrates a process flow for fixed rate JPEG encoding.

The patent or application file contains at least one drawing executed in color. Copies of this patent or patent application publication with color drawings(s) will be provided by the Office upon request and payment of the necessary fee.

### DETAILED DESCRIPTION OF THE INVENTION

JPEG baseline-coding algorithm has been established as an industry standard for image compression. The JPEG image compression standard for the compression of both grayscale and color continuous-tone still digital images is based upon the Discrete Cosine Transform (DCT) of 8×8 image blocks, followed by a lossy quantization and a lossless entropy coding (Variable Length Encoding). Performance of an image compression standard or algorithm can be measured by compression efficiency, distortion caused by compression algorithm and speed of compression and decompression. The compression efficiency is a critical parameter in view of memory requirements for storage media or bandwidth requirements of a transmission media. The compression efficiency of an encoder can be measured by the output file size or bit rate of encoding. The quantization step size for each of the DCT coefficients (obtained after the DCT of image blocks is a key parameter that controls the compression efficiency.

JPEG standard recommendation allows encoders to define set of tables referred to as “quantization tables” and “entropy-coding tables”, which are used in the process of encoding the digital image for quantization and variable length coding purposes respectively. The tables defined so by the encoder in the process of encoding controls the quality of image encoder and the compressibility or the rate of the image. The file size resulted after encoding the digital image depends on finer details in the digital image and on the quantization and entropy coding tables used. Conventionally, JPEG encoding allows using a fixed quantization table for whole image. Thus, the design of a quantization table to meet specific memory or bandwidth requirements is a design problem of collecting image statistics (image characteristics) and deriving a quantization value for a given bit rate with minimal distortion (i.e. with an optimal rate-distortion performance).

With advancements in efficient handheld, mobile devices, wireless and wire-line network systems, digital imaging field have emerged as a challenging prospect. However, limited memory systems and bandwidths demand a predictable file sizes for compressed electronic images with maximum possible quality. Consequently, many imaging applications require compressing the digital image to a pre-defined size. This problem is generally referred to be as “Rate control for Images”. Methods and systems are disclosed for encoding natural images with fixed file size (i.e. with a controlled rate of JPEG encoding). The fixed file size implies that it is guaranteed that file size is not more that a specified size, while being as close as possible to the specific size. Disclosed systems and methods address the problem of compressing the digital image using JPEG compression system with the awareness of bit rate i.e. the compressed file size.

In order to obviate the problems in existing systems and methods for controlling the rate (file size) of JPEG encoding, the disclosed systems and methods propose a single pass technique based on a new heuristic mathematical model. The model relates Discrete Cosine Transform (DCT) domain information of image properties (e.g. amplitude, perceptual importance of frequency components constituting the digital image), quantization table, and rate of encoding of the digital image. Proposed approach considers image characteristics (simple frequency characteristics of a plurality of frequency component) of a digital image and derives the corresponding quantization value based on the heuristic mathematical model. Some of the image characteristics are derived from the digital image. Subsequently, the quantization value for each frequency component is derived using the image characteristics, and bit allocated for each of the frequency components.

To this end, disclosed systems and methods enable designing of quantization table based on simple parameters of the digital image in frequency domain, which demands relatively very less complexity overhead. The proposed approach is based on empirically developed rate quantization scale models (R-Q models) that use absolute mean amplitude (image characteristic) of each frequency component of the digital image and a factor (perceptual importance) to consider it's visual importance as parameters. The entropy table definition for JPEG encoding has an underlying assumption that the number of bits to code a quantized DCT coefficient depends on the absolute range of the DCT coefficients. The absolute mean of any DCT coefficient approximately characterizes the bit requirement for that DCT coefficient. In an implementation, the method includes estimation of absolute mean amplitude of the DCT coefficients obtained after a DCT operation over a multitude of frequency components of the digital image. In contrast to the existing systems and methods, the proposed approach is simple with quick processing time thereby facilitating reduction of complexity overhead of JPEG encoding (with rate control of about 10 to 25%).

In an exemplary embodiment, the proposed approach divides the problem into two stages, one stage is for frequency domain bit-allocation of the digital image, and the other stage is for estimating the quantization scales for each of the frequency components from the rate allocated for it and associated absolute mean parameters. It may be intuitively understood that the absolute mean value of each frequency component gives a proportional weight for bit budget allocation among individual frequency components. The absolute mean of each of the frequency components is made to play an important role in the bit-allocation process.

Bit-allocation problem proposed considers a plurality of clusters (e.g. 6 clusters or frequency bands) of frequency to allocate the bits for each frequency cluster based on associated total mean amplitude strength and perceptual weight. The allocated bits for each cluster are distributed among the constituent frequency components based on the absolute means of respective frequency components. In yet another example embodiment, an exponential model is disclosed that relates the bits of individual frequency components and a corresponding quantization scale with the absolute mean as parameter. The exponential model can be utilized to derive the quantization table (quantization scale values for all the frequency components) for the digital image to implement fixed file size JPEG encoding.

### Exemplary System:

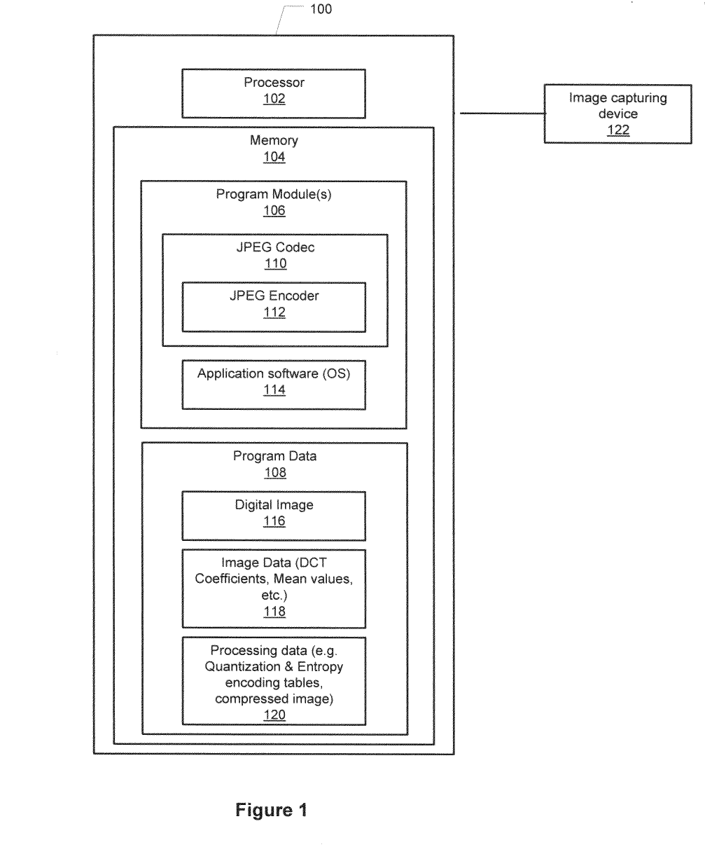

FIG. 1 shows an example of a system 100 that may implement rate controlled JPEG encoding of digital images. The system 100 may be a hand held device, a mobile phone, a camcorder, a digital still camera (DSC), and the like. The system 100 includes a processor 102 coupled to a memory 104 storing computer executable instructions. The processor 102 accesses the memory 104 and executes the instructions stored therein. The memory 104 stores instructions as program module(s) 106 and associated data in program data 8. The program module(s) 106 includes JPEG codec 110 for encoding/decoding of digital images. As shown in the figure, the JPEG codec 110 includes a JPEG encoder 112 implementing a single pass rate controlled encoding technique for encoding digital images. The program module 106 further includes other application software (Operating System) 114 required for the functioning of the system 100.

The program data 108 stores all static and dynamic data for processing by the processor in accordance with the one or more program modules. In particular, the program data 108 includes digital image 116 that stores an uncompressed digital image. It may be appreciated that for purposes of ongoing description, the uncompressed digital image may be stored in a remote image repository (not shown in the figure). The program data 108 further includes image data 120 to store information representing image characteristics and statistical data, for example, DCT coefficients, absolute mean values of the DCT coefficients, etc. The program data 108 also stores image-processing data 120 that includes data required for image processing by the program module(s) 106. Although, only selected modules and blocks have been illustrated in FIG. 1, it may be appreciated that other relevant modules for image processing and rendering may be included in the system 100. The system 100 is associated with an image capturing device 122, which in practical applications may be in-built in the system 100. The image capturing device 122 may also be external to the system 100 and may be a digital camera, a CCD (Charge Coupled Devices) based camera, a handy cam, a camcorder, and the like.

Having described a general system 100 with respect to FIG. 1, it will be understood that this environment is only one of countless hardware and software architectures in which the principles of the present invention may be employed. As previously stated, the principles of the present invention are not intended to be limited to any particular environment.

In operation, the image capturing device 122 captures an image and the system 100 receives and stores the image in digital image 116. The image so stored is uncompressed and would usually consume lot of memory and bandwidth for its storage and transmission respectively. For example, in digital still camera systems using memory cards as the storage medium, compression and encoding of the image data is required in order to record as many images as possible on the memory card. Hence, prediction of the file size and controlling during encoding of the image is necessary for a fixed memory medium where the data may be lost if the generated file size is unable to fit the available memory.

The JPEG encoder 112 enables achieves the desired bits per pixel rate (bpp)/file size or less than that for encoded (compressed) image, and maximizes both subjective and objective quality. To accomplish this, the JPEG encoder 112 designs a quantization table (quant table) matrix that is used for quantization of the digital image with an awareness of the specific rate/file size. The quantization table matrix stores quantization scale values for a plurality of frequencies that constitute the digital image. The JEPG encoder 112 controls the rate in two stages—quantization table design for given digital image and controlling encoder bits during encoding of each MCU (Minimum Coded Unit). In an exemplary implementation, the JPEG encoder 112 designs the quantization table based on Rate and Quantization scale models (R-Q models) with image complexity as a parameter.

The designing of quant table matrix that minimizes visually perceptible distortion for DCT based image coders (i.e. JPEG encoder 112) at a given rate needs to consider frequencies involved in the digital image and their perceptual importance. Accordingly, the JPEG encoder 112 considers absolute mean values of DCT components of the digital image and estimates the rate required for encoding each coefficient. The absolute values of the DCT coefficients are considered for rate quantization (R-Q) models assuming a symmetric probability distribution of DCT coefficients. The absolute mean value (of DCT coefficient) of each frequency component in the digital image is also considered assuming entropy-coding bits monotonically increase with the absolute values of the coefficients to code. The default entropy-coding table recommended in the standard satisfies the above assumption, and more over, for natural images, symmetric distribution of DCT coefficients is true. This assumption leads to the empirical derivation of rate and quantization scale models.

### Rate and Quantization Scale Model Derivation:

Based on the above assumption, a quantization scale value for each frequency component of the digital image can be related to its absolute amplitude (DCT coefficient) and bits required to code that coefficient. Thus, the overall average bits required to code a particular DCT coefficient (for a given frequency component) can be derived from the corresponding quantization step size and the average absolute amplitude. Hence, the overall file size (bit rate) requirements can be modeled based on the quantization table and average amplitudes at all frequencies from DC to maximum. In other words, the quantization table can be derived for a given file size and image characteristics (frequency, amplitude of DCT coefficients).

For designing the quantization table matrix, the digital image is divided into 8*8 sub-image blocks each of which includes one or more of a plurality of frequency components of the digital image. The digital image is considered as 64 one-dimensional signals Sᵢⱼ, each of which represents a vector of (i,j)^{th} frequency components of each sub-image block in the digital image. For example, all the DC frequency components of all 8×8 blocks of the digital image that constitutes one signal (S₀₀) and similarly for each AC coefficients, 64 signals are derived after the DCT transform for the digital image. Number of samples in each signal equals to the number of 8×8 blocks in the image. Choosing the quant scale value for all 64 vectors right from low frequency (DC) to high frequency (last AC coefficient) is the technique to design the quantization table. The statistics of each signal are collected and the quant scale is designed for each frequency component.

Sᵢⱼ={Y^{k}ᵢⱼ} for k=0 to Number of 8×8 blocks in image and i,j=0 to 63
Where the Y^{k}ᵢⱼ is (i,j)^{th} DCT coefficient of the k^{th} block of the image and Sᵢⱼ is a vector of (i,j)^{th} frequency coefficients of the image in DCT domain. As described in the previous section, the mean of the absolute frequency coefficients implies that each frequency component plays a key role for deriving the corresponding quantization scale (quant scale) for that frequency component for given coding bits at minimal distortion. Lets mᵢⱼ be the mean absolute of (i,j)^{th} frequency component of image which is given by

$${m}_{ij} = \frac{1}{N} {\sum }_{k = 0}^{N} {x}_{if}^{k} . \qquad ( 1 )$$

a, b, c are parameters of the R-D (Rate-Distortion) model and X^{k}ᵢⱼ is given by

$$\begin{matrix}{X}_{ij}^{k} = ABS ( {Y}_{ij}^{k} ) & if ABS ( {Y}_{ij}^{k} ) > Threshold \\ = 0 & else if ABS ( {Y}_{ij}^{k} ) <= Threshold .\end{matrix}$$

The DCT coefficients are clipped with a threshold to eliminate effect of noise in the digital image, which would be eliminated during quantization. The threshold is chosen as 3. The Quant matrix derivation is now considered as choosing the quant scale value for each of the vector Sᵢⱼ for given bits allocated for that frequency component in the image. The statistics of the vector can be useful for deriving the quant scale value for achieving the target bit rate for a given coding system (e.g. Huffman Table). The experimental results over wide range of image with de-facto Huffman table that is recommended in the ITU-T standard shown that the absolute mean value of vector is related to the quantization value and bits required to code that vector as follows.

$${R}_{ij} = \frac{{m}_{ij}}{c} [ ln ( \frac{b}{1 - \frac{a}{{Q}_{ij}}} ) ] \qquad ( 2 )$$

Where mᵢⱼ is mean of the (i, j)^{th} absolute DCT coefficients over all 8×8 blocks of the image as given the above, Rᵢⱼ is the number of bits required to code all (i,j)^{th} frequency component alone including its runs. In addition, Qᵢⱼ is the quantization value corresponding to the (i,j)^{th} entry of the quant table. In other words the quantization table can be derived with following equation.

$${Q}_{ij} = \frac{a}{1 - b [ exp ( \frac{- {R}_{ij} * c}{{m}_{ij}} ) ]} \qquad ( 3 )$$

Where a, b, c are parameters of R-Q models and (a,b) are empirically derived as 0.14 and 1.0002 respectively. The parameter c is key parameter for the model as it modulates the image complexity parameter mᵢⱼ. Since the mᵢⱼ not considers run level coding used in JPEG, the parameter c can be used to modulate the mᵢⱼ to account the sun length coding effects. Because the higher frequency coefficients requires more bits to code than low frequency coefficients with equal amplitude, the high frequency coefficients need to be quantized coarsely than low frequency to achieve similar bit rate. This can be done by decrementing the parameter c in stepwise with increasing frequency in zigzag order. It can observed that different images with similar mean values distribution at low frequency and high frequency side would have different compressibility. In other words, the images with much low frequency content would result less file size compared to its counter for given quantization table. Thus the image much high frequency energy need to coarsely quantized to achieve the required file size. Hence, the modulation of quant table for images with considerable high frequency content can be with parameter c as follows.

The frequency nature of image can be identified with number of significant coefficients. The Significant coefficients are computed as number of frequency coefficients from lower frequency to high frequency whose sum of mean absolute values is approximately equal to 80% of sum mean absolutes of all frequency components. Hence parameter c is computed initially based on the significant coefficients of the image as fallows.

$$c = ( \frac{1000 - SignificantCoeffcients * BitsPerBlock * 32}{{M}_{total} - {m}_{00}} ) * {10}^{- 5} \qquad ( 4 )$$

Where SignificantCoeffcients is number of significant coefficients as defined above, BitsPerBlock is average number of bits per block computed from the final output file size. In addition, Mₜₒₜₐₗ is sum of all mean values as given Eq.7 (described later), and m₀₀ is mean value of differential DC coefficients.

### Exemplary JPEG Encoder

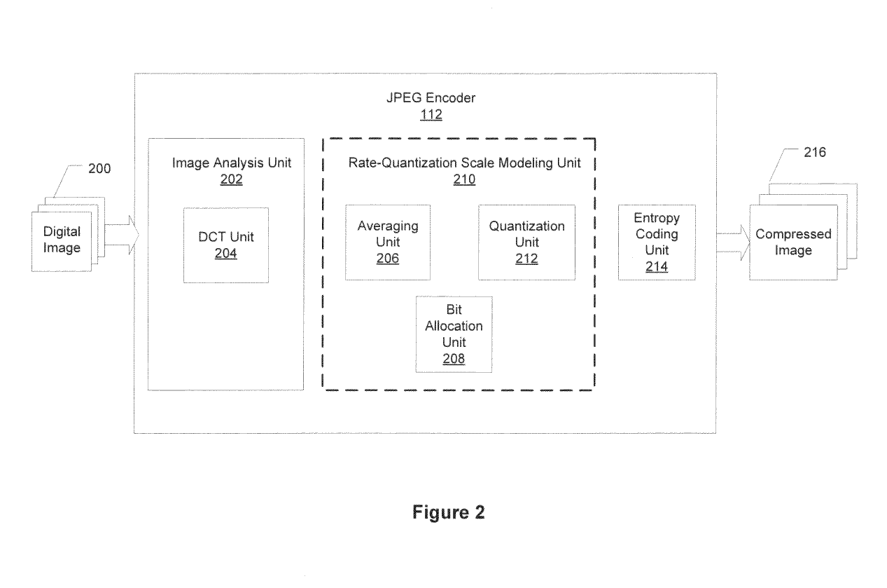

FIG. 2 illustrates the JPEG encoder 112 of FIG. 1 in an embodiment. Accordingly, JPEG encoder 112 accesses digital image 200 from program data 108 and processes to estimate image characteristics. In particular, JPEG encoder 112 includes an image analysis unit 202 that gathers image characteristics and stores it in the image data 118. In an example implementation, the image analysis unit 202 includes a DCT unit 204 that performs a Discrete Cosine Transform (DCT) over the complete digital image. As may be understood by a person skilled in the art, the digital image will be represented by a plurality of frequency components and a DCT would result in a DCT coefficient associated with each of the frequency component. The JEPG encoder includes an averaging unit 206 configured to compute average and absolute means of DCT coefficients (e.g. computations as in equation (1), (mᵢⱼ), Xᵢⱼ^{k}, equation (7)). The averaging unit 206 stores all such computed values in image data 118 for further processing by a bit allocation unit 208 in the JPEG encoder 112.

### Bit Allocation

The bit allocation unit 208 in the JPEG encoder 112 allocates bits to each of the DCT coefficients corresponding to respective frequency components. As described above, since the quantization table is based on each of the frequencies of the images, the bit allocation problem is now distribution of total bits (bit budget) across different frequencies in contrast to distribution of bits across different spatial blocks used in traditional techniques. In traditional methods, the bit allocation problem in JPEG is treated as the allocation of bits across the 8×8 spatial blocks (sub-image blocks) where the bit consumption is controlled by thresholding (or zeroing in technique).

The JPEG encoder 112 considers the individual frequencies of the digital image as being critical for the designing of the quantization table. The derivation of the quant value for each frequency component depends on the bits allocated by the bit allocation unit 208 and the mean complexity (as calculated by the averaging unit 208) of that frequency component as given in Equation 3. Hence, the distribution of given total bits across 64 frequency components of the image is critical task for designing of the quant table. In addition, all 64 frequencies are not equally perceivable by the human vision, the bit allocation unit 208 considers the human vision system (HVS) for allocation of bits. Accordingly, the less important frequency components can be allocated with fewer bits and hence a high quantization accorded with such frequency components. However, when the digital image is packed in the some high frequency components, then quantizing such frequencies coarsely will increase the distortion drastically. Hence, the bit allocation unit 208 considers the mean complexity of individual frequencies and HVS models.

The bit allocation unit 208 is based on a model that depends on perceptual weights and energy strengths of each of the frequency components. In operation, the bit allocation unit 208 orders the frequency spectrum consisting of the 64 frequency components of the digital image in a zigzag fashion as specified in JPEG standard. The bit allocation unit 208 further divided the frequency spectrum into 6 non-linear frequency bands or clusters in the order of low frequency to high frequency. Each band is given a weight factor, which is derived with its HVS perceptual importance. Each band is considered as separately for allocation of the bits based on the energy level of it and weight factor. The HVS perceptual factors are derived by energy level of the frequency band over the total energy in frequency spectrum.

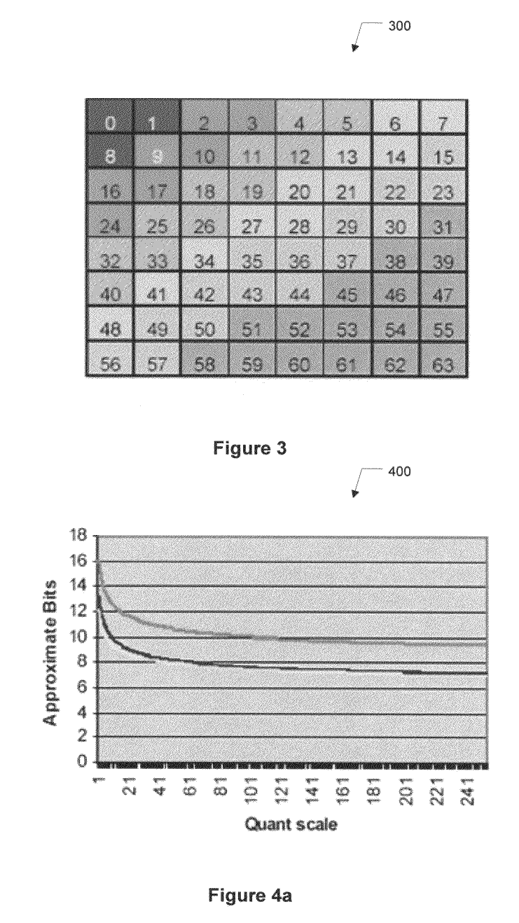

In an implementation, the number frequency components considered for six bands are 3, 7, 11, 11, 16, and 16 respectively in the order of low frequency band to high frequency band (as shown in FIG. 3 which will be described later). The bit allocation unit 208 derives the bits for each frequency component as linear distribution of total bits allocated for the given band among all the frequency components in that band. The division of frequency bands, according to an implementation, is described in FIG. 3. Each cell in FIG. 3 corresponds to a frequency component and number that identifies the cell is the frequency component location in raster scans order. The frequency-components belong to a same frequency band are grouped with same color.

The bit allocation unit carries out the bit budgeting for each pre-defined frequency band as a percentage of total bits per 8×8 sub-image block. The percentage factor is computed as a factor of mean sum of the frequency components of the given band in total mean values of the whole frequency spectrum.

Let RBₖ is bits allocated for k^{th} frequency band of six frequency bands, and Mₖ is the sum of absolute means of the frequency components belongs to the k^{th} frequency band. Then the mathematical formulation of bit allocation process can be given as follows:

$$\begin{matrix}{RB}_{k} = [ h * ( \frac{{M}_{k}}{{M}_{total}} ) ] * {B}_{TB} & ( 5 ) \\ {R}_{ij} = ( \frac{{m}_{ij}}{{M}_{k}} ) * {RB}_{k} & ( 6 )\end{matrix}$$

Where h are constant factors to weight each band based on HVS model. These values are practically derived for optimality.
Mₜₒₜₐₗ is sum of all mean values of frequencies and can be given as in Eq. 7.

$${M}_{total} = {\sum }_{i = 0}^{7} {\sum }_{j = 0}^{7} {m}_{ij} \qquad ( 7 )$$

B_{TB} is average bits per 8×8 sub-image block and is computed as in Eq.8.

$${B}_{TB} = 512 \cdot \frac{OutputFileSizeinBytes}{InputFileSizeinBytes} = \frac{OutputFileSizeinBytes}{Noof 8 x 8 BlocksInImage} \qquad ( 8 )$$

The JPEG encoder 112 further includes a quantization unit 212 configured to derive quantization scale values for the digital image. In a successive progression, the quantization unit 212 derives the quantization table matrix (a set of quantization scale values) for the digital image. The quantization table matrix stores quantization scale value corresponding to each of the 64 frequency components of the image. Hence, the quantization table matrix corresponds to 8*8 2-d array storing derived quantization scale values. The derivation of quantization scale values have been discussed in the section titled “Rate and Quantization Scale Model Derivation” in detail. In particular, the quantization unit 212 computes the quantization scale values as per equation (3) as below:

$${Q}_{ij} = \frac{a}{1 - b [ exp ( \frac{- {R}_{ij} * c}{{m}_{ij}} ) ]} \qquad ( 3 )$$

It may be appreciated that the averaging unit 206, the bit allocation unit 208, and the quantization unit 212 implement the Rate-Quantization (R-Q) Scale Modeling unit 210. Although, these blocks have been shown as separate modules in FIG. 2, it will be understood that the blocks may be arranged or grouped together to perform the requisite computations as per the R-Q Scale Model discussed earlier.

The JPEG encoder 112 further includes an entropy coding unit 214 to perform variable length encoding on the digital image using the entropy coding tables. In an implementation, the quantization table matrix (computed above) and the entropy coding table are used to compress the digital image to obtain a compressed image 216. The compressed image is stored in the processing data 120. The file size of the compressed image 216 is either equal to or less than the target size specified for the storage medium or encoding device.

### Strict Rate Control for Fixed Buffer Applications

In certain embodiments, where the output buffer (temporary memory storage, for example, image processing data 120) for storing the encoded/compressed digital image is of fixed size and is equal to target file size, a strict rate control is necessary. As the compressibility of different images varies widely, the R-Q models given above may not ensure strict rate control at byte level accuracy, though it ensures that the rate is quite near the required rate. Therefore, strict rate control requires additional means of ensuring final desired rate at each sub-image block or MCU coding level.

To address this problem, the DCT unit 204 truncates certain DCT coefficients to avoid coding of those coefficients so that the final rate is achieved. Such a truncation is performed only when the encoding rate goes beyond control. The truncation algorithm is based on finding those DCT coefficients from non-zero high frequency coefficients that need to be truncated to achieve a given file size. In other words, it would be very likely that encoding would result surpassing the target rate if the truncation is not performed at the given MCU (Minimum Coded Unit) in the image. After each MCU coding, the DCT unit 204 determines whether the final rate equals the target rate. Upon a positive determination, the truncation is performed once again. The determination is carried out repeatedly until the target rate is achieved. When the bits-per-coded blocks are far more than target bits-per-block, then future block encoding should be controlled. The JPEG encoder 112 controls the encoding in accordance with the following truncation algorithm.

Let B_{PCB} be average bits per coded 8×8 blocks and N_{B} be the remaining 8×8 blocks (to be coded). B_{PCB} is given as

$${B}_{PCB} = \frac{TotalbitsperEncodedblocks}{NumberofEncodedblocks} \qquad ( 9 )$$

Where TotalbitsperEncodedblocks is number bits consumed for encoding up to the present MCU, and NumberogEncodedblocks is number of 8×8 blocks encoded up to the present MCU. B_{PCB} is calculated after every MCU encoding is over and is checked against the target bits per block B_{TB} (as computed in equation (8)). If B_{PCB} greater than B_{TB} then rate controlling action needs to be taken on the remaining blocks to meet the final file size requirements.

Algorithm:
1. If (B_{PCB}−B_{TB})*N_{C}>N_{B} then compute number of last coefficients to be truncated as follows:

$$If ( {B}_{PCB} - {B}_{TB} ) * {N}_{C} > 3 * {N}_{B}$$

$$TrunkCoeff = \frac{( {B}_{PCB} - {B}_{TB} ) * {N}_{C}}{{N}_{B}}$$

$$Otherwise$$

$$TrunkCoeff = 1$$

2. If remaining bits is less than 8 times number of blocks to code N_{B} then only DC coefficients are allowed to code where TrunCoeff is set to 63.
3. TrunkCoeff is used to update last position of each 8×8 block as follows LastPosition=LastPosition−TrunkCoeff
   Where LastPosition is the last non-zero coefficients of 8×8 block DCT coefficients The truncation algorithm is an example of means to control the rate of encoding when the file size requirements are stringent. However, it may be appreciated that any other truncation algorithms and other similar methods may be adopted to control the rate to meet the fixed target size requirements. Such rate control mechanism ensures that the file size never goes beyond the target size (rate).

FIG. 3 shows a sub-imager block of the digital image illustrating six non-linear frequency bands. As discussed earlier, the bit allocation unit 208 derives the bits for each frequency component as linear distribution of total bits allocated for the given band among all the frequency components in that band. The division of frequency bands, according to an implementation, is described in FIG. 3. Each cell in FIG. 3 corresponds to a frequency component and number that identifies the cell is the frequency component location in raster scans order. The frequency-components belong to a same frequency band are grouped with same color.

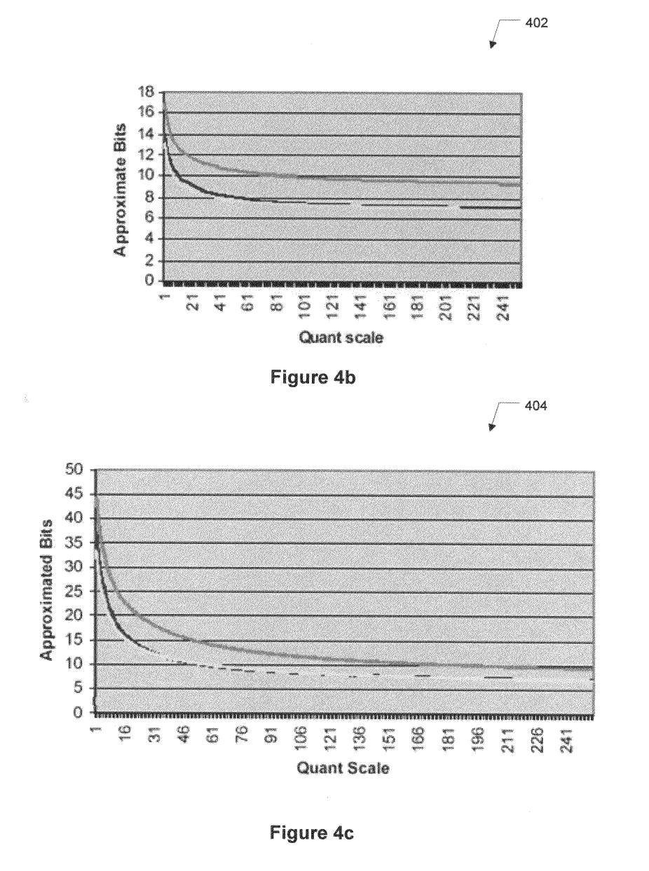

FIGS. 4a, FIG. 4b, FIG. 4c show graphs 400, 402, and 404 of quantization values versus resulting average number of bits to code: differential DC coefficients, first AC coefficients and average bits required to code first four coefficients in zigzag fashion for three typical images respectively. The average bits shown in the figures are computed as the bits required to code the particular coefficient or set of coefficients while all the remaining coefficients are quantized coarsely with a fixed number (e.g. 255). The graphs indicate that the quant scale and the bits to code a particular DCT coefficient of the digital image are related exponentially with image complexity as a parameter. A similar relation can be identified for all other DCT coefficients. This empirical data is the guiding principle for the R-Q Scale models discussed above with image statistics (characteristics) as a parameter.

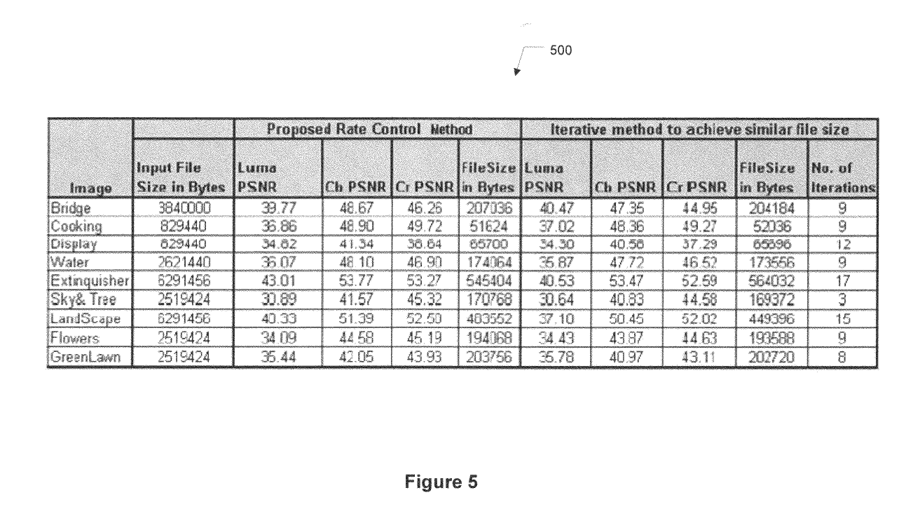

FIG. 5 illustrates a table 500 that captures performance data associated with the single pass technique and iterative technique for controlled rate encoding according to the disclosed methods and systems. Fixed rate JPEG encoding algorithm implementing the disclosed R-Q Scale model is tested over many color formats and many digital images of sizes covering 0.3 mega pixels to 5 mega pixels. For the given output file size of encoder, the rate control algorithm always achieves the file size less than the output file size. The fixed rate JPEG encoding algorithm is a single pass technique that has a negligible computational complexity. In certain scenarios, a frame buffer is required for storing the DCT coefficients for encoding at a later stage. However, the frame buffer can be avoided with approximately 20-30% increase in the computational complexity of JPEG encoder.

It is appreciated that the rate control mechanisms disclosed herein is designed for situation where output buffer size is restricted and fixed, and the encoded file size would be considerably less than the output buffer size. Hence, an iterative technique may be applied in to achieve a given file size. Such an implementation is based on a scaling the de-facto quant table (quantization provided by the JPEG standard) with a scale factor or quality factor, and subsequently encoding the digital image with the quantization table so designed. The scale factor or the quality factor may be adjusted iteratively until the compressed file size becomes less than the target size.

Comparative results for the disclosed single pass technique and the conventional iterative technique are given in the table 500 as shown in FIG. 5. The table 500 includes fields like: type of image, input file size, Peak signal-to-noise Ratios (PSNR) for Luma, Chroma components, output file size, and number of iterations it took for the iterative technique. It may be understood from the table 500 that the iterative technique achieve final target with accuracy but at an impractical computational complexity. In contrast, the disclosed systems and methods provide for a single pass rate control technique while maintaining the subjective and objective quality with negligible complexity cost

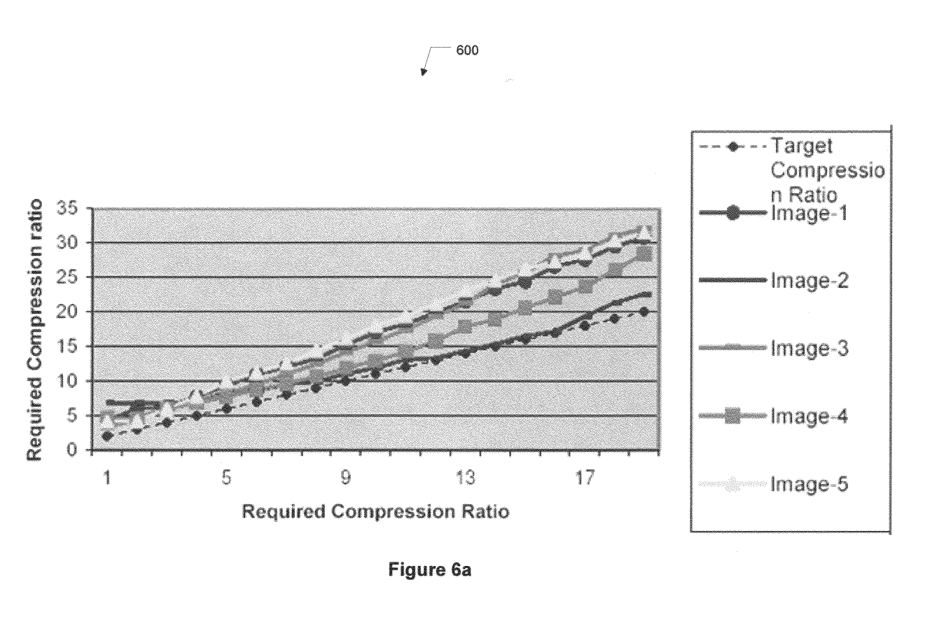

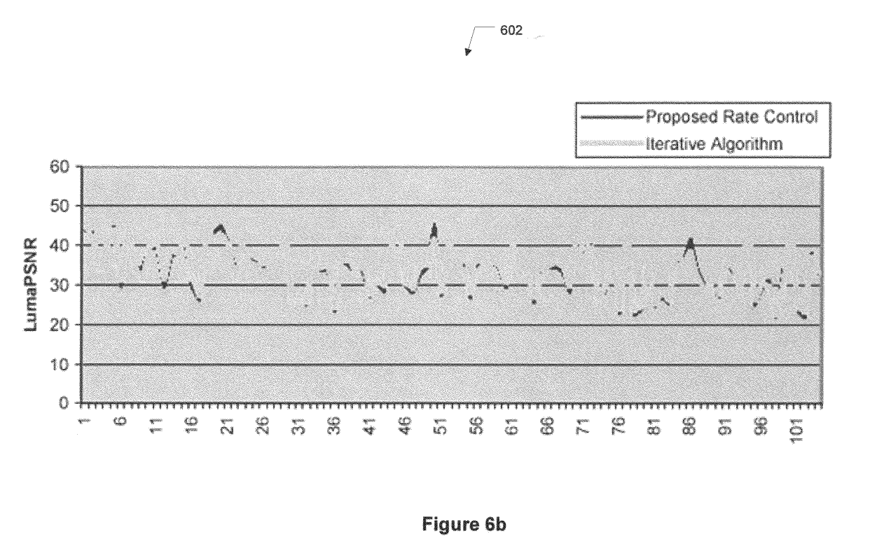

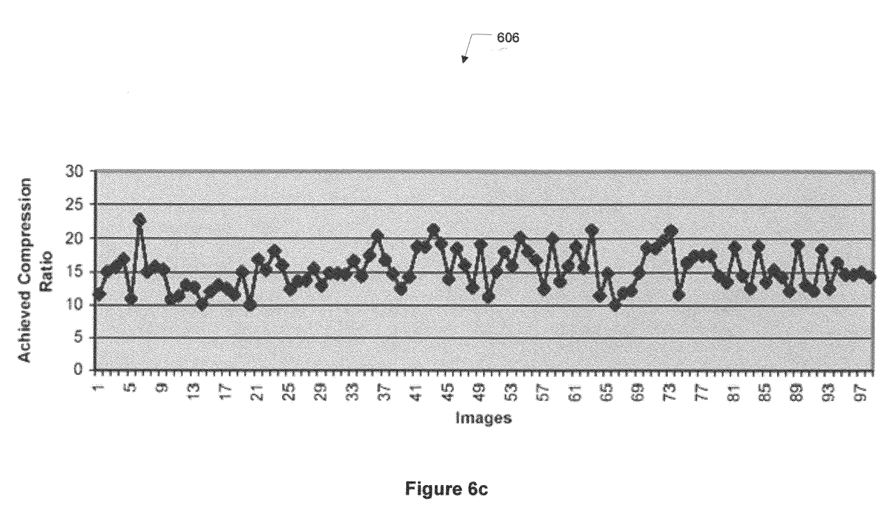

FIG. 6a illustrates a graph 600 of the transfer characteristics (required versus achieved compression ratios) for five natural images achieved with rate controlled JPEG encoding according to the present invention.

FIG. 6b illustrates a graph of the PSNR characteristics for different images when compressed using the proposed rate control technique as against the conventional iterative technique. It can be understood that the Rate-Distortion (R-D) performance of the proposed rate control technique is very close to that of the iterative technique.

FIG. 6c illustrates a graph between compression ratios and number of images (over 100) with a target compression ratio of 15 being compressed in accordance with the disclosed rate control JPEG encoding.

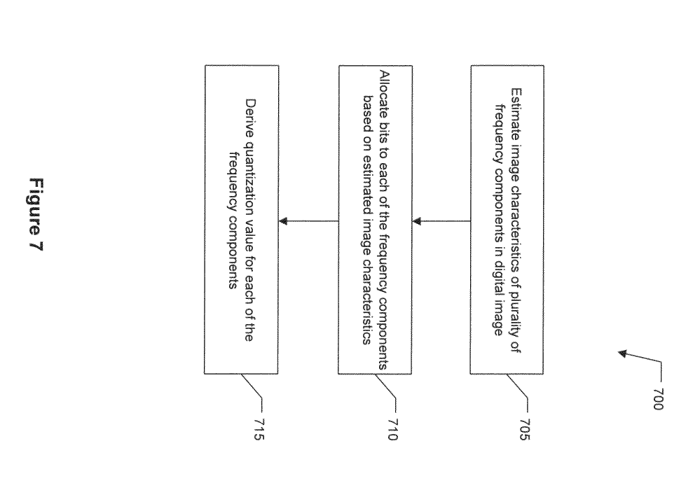

FIG. 7 illustrates a process 700 for rate controlled JPEG encoding of a digital image according to an implementation. Description of the process 700 is with reference to FIG. 1-6 described in detail in the earlier sections. At step 705, image characteristics of a plurality of frequency components in a digital image are estimated. In an implementation, the image analysis unit 202 estimates the image characteristics associated with the digital image. In operation, the DCT unit 204 performs a block based DCT over the plurality of frequency components to obtain DCT coefficients (image characteristics/statistical data) corresponding to each of the frequency components. The DCT coefficients are stored in the image data 118 of the system 100. In an alternative embodiment, estimating of image characteristics include computing a mean of DCT coefficients. The averaging unit 206 determines the mean of individual DCT coefficients and total mean of all the DCT coefficients.

At step 710, bits are allocated to each of the frequency components based on estimated image characteristics. The bit allocation unit 208 considers a sub-image block having 64 (8*8) pixels. The complete frequency spectrum of the digital image is divided into a plurality of non-linear bands or clusters. In an implementation, the bit allocation unit 208 divides the spectrum into 6 non-linear frequency bands and classifies the frequency components according to the frequency bands as shown in FIG. 3. Subsequently, the bit allocation unit 208 allocates encoding bits to each of the frequency components (equations (5) & (8)). In an alternative embodiment, allocating bits include assigning a weight to each of the 6 non-linear frequency bands. The weight is derived in accordance with a corresponding perceptual importance in the Human Visual System (HVS).

At step 715, quantization value is derived for each of the frequency components. The quantization unit 212 derives the quantization scale value (as per equation (3)) based on the allocated bits at step 710 and the estimated image characteristics (e.g. mean DCT coefficients).In an alternative implementation, quantization value derivation is based on modulated image complexity (“c” in equation (3)).

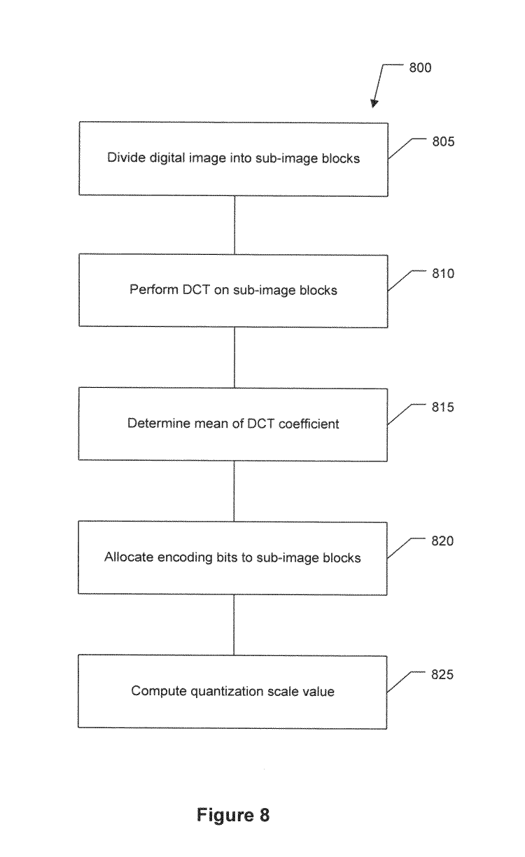

FIG. 8 illustrates a process flow 800 for fixed rate JPEG encoding according to an example implementation. Description of the process 800 is with reference to FIG. 1-6 described in detail in the earlier sections. At step. 805, the digital image is divided into sub-image blocks. The image analysis unit 202 divides the digital image into a plurality of 8*8 sub-image blocks. In an example implementation, the digital image is defined as composite of a plurality of frequency components. Therefore, each sub-image block may have associated with it the plurality of frequency components.

At step 810, a DCT is performed on the sub-image blocks. The DCT unit 204 performs a Discrete Cosine Transform (DCT) over the sub-image blocks of the digital image. The DCT results in DCT coefficients for each of the frequency components in the sub-image block. The DCT unit 204 stores the DCT coefficients in the image data 118.

At step 815, mean of DCT coefficients is determined. The averaging unit 206 determines the individual and total mean of DCT coefficients associated with each of the sub-image block. The averaging unit stores the mean in the image data 118.

At step 820, bits are allocated to the sub-image blocks (i.e. constituent frequency components) of the digital image. The bit allocation unit 208 allocates encoding bits to each of the frequency components (equations (5) & (8)). In an implementation, the bit allocation unit 208 divides the spectrum into 6 non-linear frequency bands and assigning a weight to each of the 6 non-linear frequency bands.

At step 825, a quantization scale value is computed for each of the sub-image block. The quantization unit 212 computes a quantization table matrix for the digital image. The quantization table matrix stores quantization scale value corresponding to each of the frequency components of the image. Hence, the quantization table matrix corresponds to 8*8 2-d array storing derived quantization scale values for 64 frequency components. In an implementation, the quantization unit 212 determines an image complexity parameter associated with each of the image sub blocks. The image complexity parameter enables specific consideration of high frequency components in each of the image sub-block in the digital image.

In certain embodiments, where the output buffer (temporary memory storage, for example, image processing data 120) for storing the encoded/compressed digital image is of fixed size and is equal to target file size, a strict rate control is necessary. To address this problem, the DCT unit 204 truncates certain DCT coefficients to avoid coding of those coefficients so that the final rate is achieved. The truncation algorithm is based on finding those DCT coefficients from non-zero high frequency coefficients that need to be truncated to achieve a given file size.

It will be appreciated that the teachings of the present invention can be implemented as a combination of hardware and software. The software is preferably implemented as an application program comprising a set of program instructions tangibly embodied in a computer readable medium. The application program is capable of being read and executed by hardware such as a computer or processor of suitable architecture. Similarly, it will be appreciated by those skilled in the art that any examples, flowcharts, functional block diagrams and the like represent various exemplary functions, which may be substantially embodied in a computer readable medium executable by a computer or processor, whether or not such computer or processor is explicitly shown. The processor can be a Digital Signal Processor (DSP) or any other processor used conventionally capable of executing the application program or data stored on the computer-readable medium

The example computer-readable medium can be, but is not limited to, (Random Access Memory) RAM, (Read Only Memory) ROM, (Compact Disk) CD or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

I/we claim:

1. A method of controlling rate of Joint Pictures Experts Group (JPEG) encoding of a digital image, the method comprising;
estimating image characteristics of a plurality of frequency components associated with the digital image;
allocating bits to each of the plurality of frequency components based at least in part on the estimated image characteristics; and
deriving a quantization value for each of the plurality of frequency components based at least in part on the estimated image characteristics and corresponding allocated bits, the quantization value resulting in a controlled rate of JPEG encoding.

2. The method as in claim 1, wherein the estimating comprises performing a block based Discrete Cosine Transform (DCT) over the plurality of frequency components.

3. The method as in claim 2, wherein the estimating further comprises computing a mean of Discrete Cosine Transform (DCT) coefficients for each of the plurality of frequency components.

4. The method as in claim 1, wherein the allocating comprises:
classifying the frequency components into six non-linear frequency bands representing different energy levels; and
allocating bits to each of the non-linear frequency bands.

5. The method as in claim 4, wherein the allocating comprises assigning a weight to each of the six non-linear frequency bands, the weight being derived in accordance with a corresponding Human Visual System (HVS) perceptual importance.

6. The method as in claim 1, wherein the deriving is based at least in part on modulated image complexity.

7. A system for performing a fixed rate JPEG encoding of a digital image, the system comprising:
an image analysis unit configured to estimate statistical details associated with a plurality of frequency components in the digital image;
a bit allocation unit configured to:
classify the plurality of frequency components into a plurality of non-linear frequency bands representing different energy levels;
allocate bits to each of the plurality of non-linear frequency bands; and
a quantization unit configured to determine a quantization scale value for each of the plurality of frequency component based at least in part on the estimated statistical details and the allocated bits.

8. The system as in claim 7, wherein the image analysis unit comprises:
a Discrete Cosine Transform (DCT) unit configured to perform DCT over the plurality of frequency components; and
an averaging unit configured to compute an average of DCT coefficients associated with the plurality of frequency components.

9. The system as in claim 7, wherein, the image analysis unit is further configured to estimate statistical details associated with 64 frequency components of the digital image.

10. The system as in claim 7, wherein the bit allocation unit is further configured to distribute the allocated bits amongst the plurality of frequency components classified under each of the plurality of non-linear frequency bands.

11. The system as in claim 7, wherein the bit allocation unit is further configured to assign a weight to each of the plurality of non-linear bands, the weight being derived in accordance with a corresponding Human Visual System (HVS) perceptual importance.

12. The system as in claim 8, wherein the quantization unit is further configured to quantize DCT coefficients of each of the plurality of frequency components based on the corresponding quantization scale value.

13. The system as in claim 7, wherein the quantization unit is further configured to determine the quantization scale value based at least in part on an image complexity parameter.

14. The system as in claim 7, wherein the quantization unit is further configured to determine a quantization table for the digital image, the quantization table storing quantization scale values for each of the plurality of the frequency components.

15. The system as in claim 7 further comprises an entropy-coding unit configured to perform a lossless compression of the digital image in accordance with an entropy-coding table.

16. A computer-readable medium having computer-executable instructions for rate controlled Joint Pictures Expert Group (JPEG) encoding of a digital image, the computer executable instructions comprising modules for:
dividing the digital image into a plurality of sub-image blocks,
performing a Discrete Cosine Transform (DCT) on each of the plurality of sub-image blocks;
determining a mean of the DCT coefficients associated with each of the plurality of sub-image blocks;
allocating encoding bits to each of the plurality of sub-image blocks based at least in part on the computed mean of the DCT coefficients; and
computing a quantization scale value for each of the plurality of sub-image blocks based at least on the allocated bits and image complexity of each of the plurality of sub-image blocks.

17. The computer readable medium of claim 16, wherein the computer executable instructions comprises modules for storing the DCT coefficients for future computations.

18. The computer readable medium of claim 16, wherein the computer executable instructions comprises modules for truncating the DCT coefficients associated with one or more of the plurality of sub-image blocks based on a perceptual importance of each of the plurality of sub-image blocks.

19. The computer readable medium of claim 16, wherein the computing comprises determining an image complexity parameter associated with each of the plurality of sub-image blocks.

20. The computer readable medium of claim 16, wherein the allocating comprises:
classifying the plurality of sub-image blocks into six non-linear frequency bands; and
assigning weights to the non-linear frequency bands.
